(19) United States
(12) Patent Application Publication
(10) Pub. No.: US 2019/0135319 A1
(43) Pub. Date: May 9, 2019

(54) Collector of Lawn Waste

(71) Applicant: Brian Wayne Kemper, Walnut Creek, CA (US)

(72) Inventor: Brian Wayne Kemper, Walnut Creek, CA (US)

(21) Appl. No.: 16/140,884

(22) Filed: Sep. 25, 2018

Related U.S. Application Data
(60) Provisional application No. 62/583,329, filed on Nov. 8, 2017.

(51) Int. Cl. B62B 1/14; B65F 1/00; B65F 3/00

(52) U.S. Cl. CPC B62B 1/147; B65F 1/00; B62B 2202/50; B65F 2240/138; B65F 3/005

(57) ABSTRACT

A collector of yard waste is an apparatus that is used to collect items and debris from a yard. The apparatus includes a receptacle, a shovel lip, a first wheel, a second wheel, and a guide rope. The receptacle is a container in which the user can store trash, debris, and other such waste for subsequent disposal, and is further utilized as a structural mechanism for arranging the other components. The shovel lip provides a way for the user to drag the present invention into a pile of foliage or trash and provides a simple mechanism for adding items to the receptacle. The first wheel and the second wheel are arranged on a shared axis to provide a mechanism for moving the present invention from place to place. The guide rope extends from the collector to allow a user to pull the present invention along during use.

The current application claims a priority to the U.S. Provisional Patent application Ser. No. 62/583,329 filed on Nov. 8, 2017.

### FIELD OF THE INVENTION

The present invention generally relates to a foliage collection tool. More specifically, the present invention relates to a device capable of collecting and storing sticks, leaves, trash, debris, and more during yard maintenance work.

### BACKGROUND OF THE INVENTION

As a result of the baby boom of the 50's, families have migrated en masse to the suburbs. Such environments are perceived as being safer for raising children than cities and have more to offer than cramped apartments. Specifically, suburban households often have front and back yards, which are excellent for providing stimulating environments for children. In order to properly enjoy a yard, a user must maintain their yard. Lawnmowers and rakes are essential equipment for combating the effects of unkempt nature. Foliage must be removed to the street to be taken by the garbage truck or at least to leave the lawn in presentable condition.

To this end, a variety of yard receptacles are used for retaining debris and the like. Yard receptacles provide a convenient storage unit for trash, debris, and the like. Yard receptacles are typically setup vertically with an opening at the top for receiving trash, debris, and the like. This allows the user to deposit items by placing a receptacle on the yard and moving foliage from the lawn into the receptacle by making multiple trips. One inconvenience with yard receptacles is that the individual must first pick up the trash, debris and the like and then transfer the material to the yard receptacle. This adds another step to be performed by an individual. Additionally, yard receptacles are difficult to move around with or without retained trash, debris, or the like. As such a receptacle fills, it becomes heavier, resulting in less efficient garbage removal. What is needed is a device that can collect foliage and other objects without requiring multiple trips to and from the receptacle. Further desirable is a device which can easily move with the user, enabling easier addition of items.

The present invention addresses these issues. It is an objective of the present invention to provide a horizontal yard receptacle that moves along the ground to remove items. The present invention includes a container body with wheels and a shovel portion for scooping up foliage. The arrangement of the wheels opposite the shovel portion allows the user to easily roll the present invention, via the wheels, on a surface to scoop up trash, debris and the like. The present invention further includes rope outlets, which allow the user to string rope or cord through the present invention. This rope or cord, along with an attached pull-string, allows the user to elevate the present invention at an angle as an aid in moving the trash, debris and the like into the container body.

### BRIEF DESCRIPTION OF THE DRAWINGS

FIG. 1 is a front-left perspective view of the present invention.

FIG. 2 is a top view of the present invention.

FIG. 3 is a left view of the present invention.

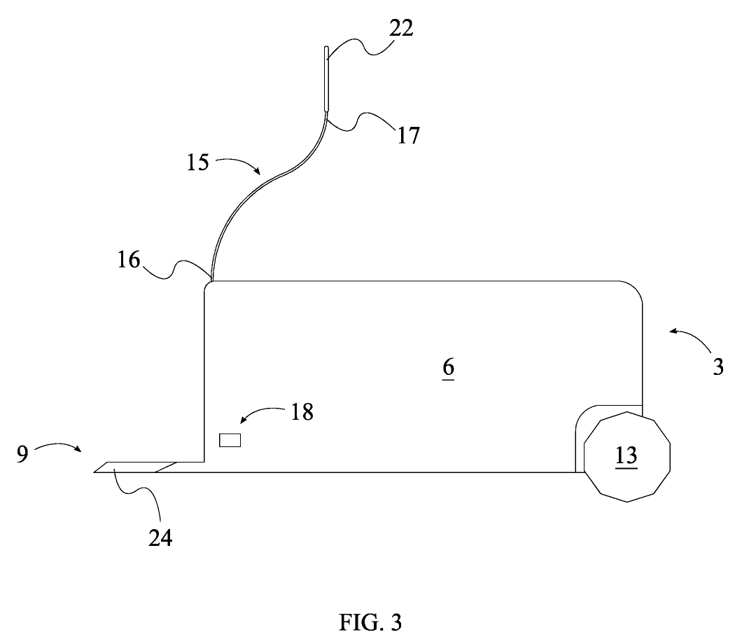

FIG. 4 is a front view of the present invention.

FIG. 5 is a detail view of the first anchor taken about circle 5 in FIG. 4.

### DETAILED DESCRIPTION OF THE INVENTION

All illustrations of the drawings are for the purpose of describing selected versions of the present invention and are not intended to limit the scope of the present invention.

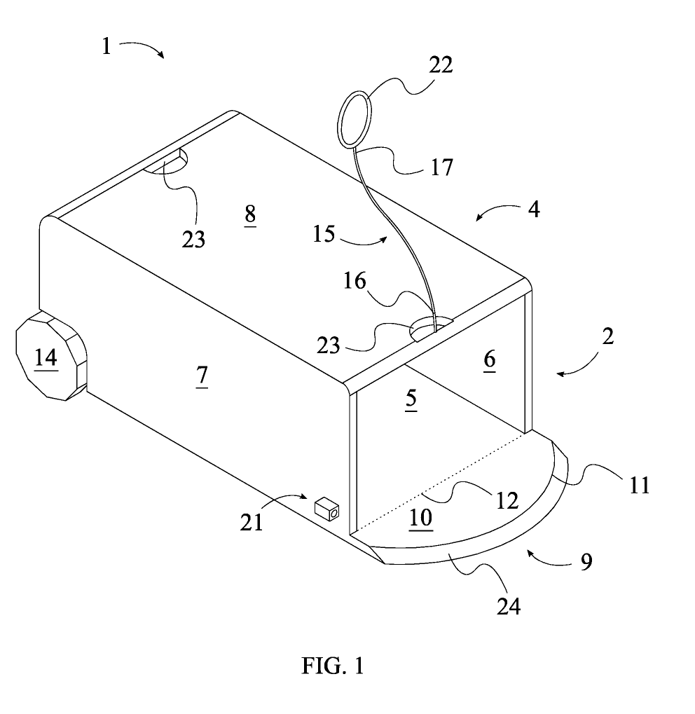

A collector of yard waste is an apparatus that is used to collect items and debris from a yard. The present invention provides a convenient way to move collected items between locations. The apparatus includes a receptacle 1, a shovel lip 9, a first wheel 13, a second wheel 14, and a guide rope 15, as seen in FIG. 1. The receptacle 1 is a container in which the user can store trash, debris, and other such waste for subsequent disposal and is further utilized as a structural mechanism for arranging the other components. The shovel lip 9 provides a way for the user to drag the present invention into a pile of foliage or trash and provides a simple mechanism for adding items to the receptacle 1. The first wheel 13 and the second wheel 14 are arranged on a shared axis to provide a mechanism for moving the present invention from place to place. The guide rope 15 extends from the collector to allow a user to pull the present invention along during use.

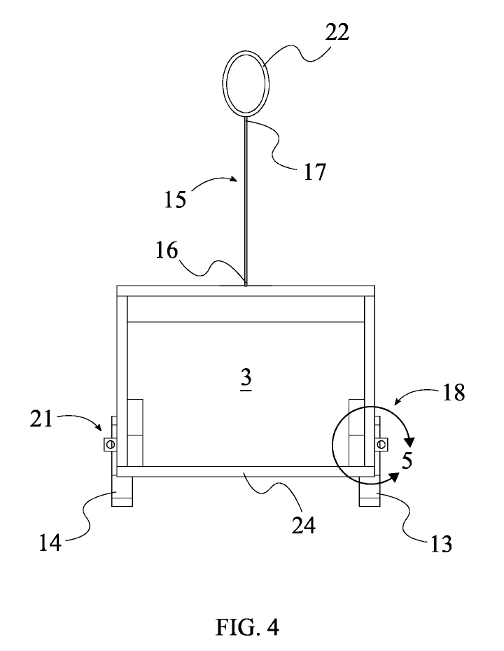

The general configuration of the aforementioned components allows the present invention to efficiently and effectively collect waste during lawn maintenance. The receptacle 1 comprises an open end 2, a lateral wall 4, and a closed end 3. The open end 2 is the area in which items can enter and exit the receptacle 1. The lateral wall 4 is the segment of the receptacle 1 that keeps contained items from falling out of the receptacle 1. The closed end 3 is the section of the receptacle 1 that also prevents items from falling out of the receptacle 1 due to gravity, as seen in FIG. 4. The lateral wall 4 comprises a flat portion 5. The flat portion 5 allows the present invention to lay flat on the ground, enabling easy addition of items into the receptacle 1. The guide rope 15 comprises a first rope end 16 and a second rope end 17. The first rope end 16 is a section of the guide rope 15 connected to the lateral wall 4. The second rope end 17 is the section of the guide rope 15 that allows for grasping and subsequent use of the guide rope 15. The shovel lip 9 is connected adjacent to the flat portion 5. Further, the shovel lip 9 is positioned adjacent to the open end 2. This arrangement allows a smooth transfer of items from the shovel lip 9 to the receptacle 1.

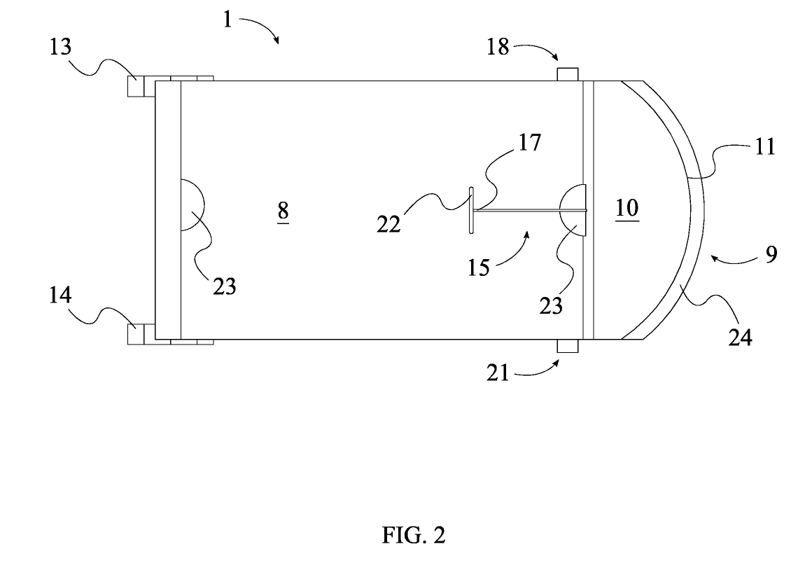

In addition, the first wheel 13 and the second wheel 14 are rotatably connected to the lateral wall 4. This enables the first wheel 13 and the second wheel 14 to rotate together relative to the receptacle 1. The first wheel 13 and the second wheel 14 are positioned opposite each other across the flat portion. This provides the present invention a mechanism for balancing while the user moves the receptacle 1. Furthermore, the first wheel 13 and the second wheel 14, as seen in FIG. 2, are positioned adjacent to the closed end 3. This arrangement allows the present invention to roll as a means of moving items from place to place by lifting the receptacle 1, opposite the open end 2. The first rope end 16 is externally connected to the lateral wall 4. In this way, the guide rope 15 may be utilized to pull the present invention between locations. The first rope end 16 and the shovel lip 9 are positioned opposite to each other about the open end 2. This arrangement allows the user to move the present invention by pulling the guide rope 15, thus shifting the weight of the contents of the receptacle 1 onto the first wheel 13 and the second wheel 14.

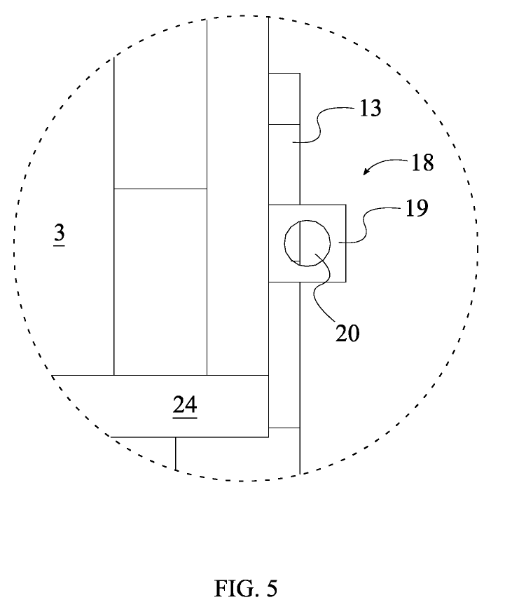

The shovel lip 9 may be utilized as a lifting mechanism for waste and the like, but only when utilized at the proper angle. To this end, the present invention comprises a first anchor 18 and a second anchor 21. The first anchor 18 and the second anchor 21 are support points that allow for supplemental control to be added to the present invention, particularly in the form of additional ropes or handles. The first anchor 18 and the second anchor 21 are positioned adjacent to the open end 2. This positions additional ropes or handles appropriately for moving the receptacle 1. Further, the first anchor 18 and the second anchor 21 are positioned opposite to each other about the open end 2. This arrangement allows the user to connect a supplemental rope or cord that can be used to pull or move the present invention. The first anchor 18 and the second anchor 21 each comprise an anchor body 19 and a rope-receiving hole 20, as seen in FIG. 5. The rope-receiving hole 20 traverses through the anchor body 19. This arrangement provides a way for the external connector to join to the present invention. The rope-receiving hole 20 is oriented towards the open end 2. In this way, an attached connector may be oriented appropriately for pulling the present invention. Furthermore, the present invention comprises a looped handle 22. The looped handle 22 is a connector that allows the user to conveniently grasp the guide rope 15. The looped handle 22 is connected onto the second rope end 17. In this way, the looped handle 22 is arranged advantageously for use in pulling the present invention during use.

The present invention is made more efficient and effective by increasing the available volume within the receptacle 1. To this end, the lateral wall 4 further comprises a first side wall 6, a second side wall 7, and a top wall 8, as seen in FIG. 1. The arrangement of the first side wall 6, the second side wall 7, and the top wall 8 increases the available volume within the receptacle 1. In an exemplary embodiment, the first side wall 6 and the second side wall 7 are connected adjacent and perpendicular to the flat portion 5. Further, the first side wall 6 and the second side wall 7 are positioned opposite to each other across the flat portion 5. This creates a square cross-section of the receptacle 1, which is advantageous both for collecting dirt and debris, for storage purposes, and for subsequently transporting such contents. The top wall 8 is connected perpendicular to the first side wall 6 and the second side wall 7, opposite to the flat portion 5. This arrangement completes the containment volume of the receptacle 1.

In several embodiments, the user may require another mechanism for moving the present invention. To this end, the present invention further comprises a recessed handle 23. The recessed handle 23 traverses through the lateral wall 4. This arrangement allows the user to grasp the receptacle 1 directly, as opposed to moving the receptacle 1 by leveraging the guide rope 15. The recessed handle 23 is positioned opposite the flat portion 5, as seen in FIG. 2. This increases the convenience of utilizing the recessed handle 23 as a way to move the present invention. The recessed handle 23 is positioned adjacent to the open end 2. This arrangement ensures that the recessed handle 23 is positioned optimally for utilizing the first wheel 13 and the second wheel 14 to move the present invention. In an exemplary embodiment, the recessed handle 23 may extend through the flat portion 5, providing an alternative mechanism for pulling or otherwise moving the present invention.

As an alternative way to remove items from the ground, the user may utilize the shovel lip 9. The shovel lip 9 comprises a lip body 10, a rounded edge 11, and a straight edge 12. The lip body 10 allows for arrangement of the rounded edge 11 and the straight edge 12, as seen in FIG. 1. The straight edge 12 joins the shovel lip 9 to the receptacle 1. The rounded edge 11 and the straight edge 12 are positioned opposite each other across the lip body 10. The straight edge 12 is connected adjacent to the flat portion 5. This allows proper arrangement of the rounded edge 11 relative to the receptacle 1. Further, the present invention comprises a rounded wedge 24. The rounded wedge 24 is a tapered extrusion that facilitates addition of items to the receptacle 1. The rounded wedge 24 is perimetrically connected about the rounded edge 11. This arrangement allows the rounded wedge 24 to be used to lift items.

Although the invention has been explained in relation to its preferred embodiment, it is to be understood that many other possible modifications and variations can be made without departing from the spirit and scope of the invention as hereinafter claimed.

What is claimed is:

1. A collector of lawn waste comprises:
a receptacle;
a shovel lip;
a first wheel;
a second wheel;
a guide rope;
the receptacle comprises an open end, a lateral wall, and a closed end;
the lateral wall comprises a flat portion;
the guide rope comprises a first rope end and a second rope end;
the shovel lip being connected adjacent to the flat portion;
the shovel lip being positioned adjacent to the open end;
the first wheel and the second wheel being rotatably connected to the lateral wall;
the first wheel and the second wheel being positioned opposite to each other across the flat portion;
the first wheel and the second wheel being positioned adjacent to the closed end;
the first rope end being externally connected to the lateral wall; and
the first rope end and the shovel lip being positioned opposite to each other about the open end.

2. The collector of lawn waste as claimed in claim 1 comprises:
a first anchor;
a second anchor;
the first anchor and the second anchor being positioned adjacent to the open end; and
the first anchor and the second anchor being positioned opposite to each other about the open end.

3. The collector of lawn waste as claimed in claim 2 comprises:
the first anchor and the second anchor each comprise an anchor body and a rope-receiving hole;
the rope-receiving hole traversing through the anchor body; and
the rope-receiving hole being oriented towards the open end.

4. The collector of lawn waste as claimed in claim 1 comprises:
a looped handle; and
the looped handle being connected onto the second rope end.

5. The collector of lawn waste as claimed in claim 1 comprises:
the lateral wall further comprises a first side wall, a second side wall, and a top wall;
the first side wall and the second side wall being connected adjacent and perpendicular to the flat portion;
the first side wall and the second side wall being positioned opposite to each other across the flat portion; and
the top wall being connected perpendicular to the first side wall and the second side wall, opposite to the flat portion.

6. The collector of lawn waste as claimed in claim 1 comprises:
a recessed handle;
the recessed handle traversing through the lateral wall;
the recessed handle being positioned opposite the flat portion; and
the recessed handle being positioned adjacent to the open end.

7. The collector of lawn waste as claimed in claim 1 comprises:
the shovel lip comprises a lip body, a rounded edge, and a straight edge;
the rounded edge and the straight edge being positioned opposite each other across the lip body; and
the straight edge being connected adjacent to the flat portion.

8. The collector of lawn waste as claimed in claim 7 comprises:
a rounded wedge; and
the rounded wedge being perimetrically connected about the rounded edge.

9. A collector of lawn waste comprises:
a receptacle;
a shovel lip;
a first wheel;
a second wheel;
a guide rope;
a first anchor;
a second anchor;
the receptacle comprises an open end, a lateral wall, and a closed end;
the lateral wall comprises a flat portion;
the guide rope comprises a first rope end and a second rope end;
the shovel lip being connected adjacent to the flat portion;
the shovel lip being positioned adjacent to the open end;
the first wheel and the second wheel being rotatably connected to the lateral wall;
the first wheel and the second wheel being positioned opposite to each other across the flat portion;
the first wheel and the second wheel being positioned adjacent to the closed end;
the first rope end being externally connected to the lateral wall;
the first rope end and the shovel lip being positioned opposite to each other about the open end;
the first anchor and the second anchor being adjacent to the open end; and
the first anchor and the second anchor being positioned opposite to each other about the open end.

10. The collector of lawn waste as claimed in claim 9 comprises:
the first anchor and the second anchor each comprise an anchor body and a rope-receiving hole;
the rope-receiving hole traversing through the anchor body; and
the rope-receiving hole being oriented towards the open end.

11. The collector of lawn waste as claimed in claim 9 comprises:
a looped handle; and
the looped handle being connected onto the second rope end.

12. The collector of lawn waste as claimed in claim 9 comprises:
the lateral wall further comprises a first side wall, a second side wall, and a top wall;
the first side wall and the second side wall being connected adjacent and perpendicular to the flat portion;
the first side wall and the second side wall being positioned opposite to each other across the flat portion; and
the top wall being connected perpendicular to the first side wall and the second side wall, opposite to the flat portion.

13. The collector of lawn waste as claimed in claim 9 comprises:
a recessed handle;
the recessed handle traversing through the lateral wall;
the recessed handle being positioned opposite the flat portion; and
the recessed handle being positioned adjacent to the open end.

14. The collector of lawn waste as claimed in claim 9 comprises:
the shovel lip comprises a lip body, a rounded edge, and a straight edge;
the rounded edge and the straight edge being positioned opposite each other across the lip body; and
the straight edge being connected adjacent to the flat portion.

15. The collector of lawn waste as claimed in claim 14 comprises:
a rounded wedge; and
the round wedge being perimetrically connected about the rounded edge.

16. A collector of lawn waste comprises:
a receptacle;
a shovel lip;
a first wheel;
a second wheel;
a guide rope;
a first anchor;
a second anchor;
a rounded wedge;
the receptacle comprises an open end, a lateral wall, and a closed end;
the lateral wall comprises a flat portion;
the guide rope comprises a first rope end and a second rope end;
the shovel lip comprises a lip body, a rounded edge, and a straight edge;
the shovel lip being connected adjacent to the flat portion;
the shovel lip being positioned adjacent to the open end;
the first wheel and the second wheel being rotatably connected to the lateral wall;
the first wheel and the second wheel being positioned opposite to each other across the flat portion;
the first wheel and the second wheel being positioned adjacent to the closed end;
the first rope end being externally connected to the lateral wall;
the first rope end and the shovel lip being positioned opposite to each other about the open end;
the first anchor and the second anchor being adjacent to the open end;
the first anchor and the second anchor being positioned opposite to each other about the open end;
the rounded edge and the straight edge being positioned opposite each other across the lip body;
the straight edge being connected adjacent to the flat portion; and
the round wedge being perimetrically connected about the rounded edge.

17. The collector of lawn waste as claimed in claim 16 comprises:
the first anchor and the second anchor each comprise an anchor body and a rope-receiving hole;
the rope-receiving hole traversing through the anchor body; and
the rope-receiving hole being oriented towards the open end.

18. The collector of lawn waste as claimed in claim 16 comprises:
a looped handle; and
the looped handle being connected onto the second rope end.

19. The collector of lawn waste as claimed in claim 16 comprises:
the lateral wall further comprises a first side wall, a second side wall, and a top wall;
the first side wall and the second side wall being connected adjacent and perpendicular to the flat portion;
the first side wall and the second side wall being positioned opposite to each other across the flat portion; and
the top wall being connected perpendicular to the first side wall and the second side wall, opposite to the flat portion.

20. The collector of lawn waste as claimed in claim 16 comprises:
a recessed handle;
the recessed handle traversing through the lateral wall;
the recessed handle being positioned opposite the flat portion; and
the recessed handle being positioned adjacent to the open end.
